(19) United States
(12) Patent Application Publication
(10) Pub. No.: US 2006/0168157 A1
(43) Pub. Date: Jul. 27, 2006

(54) Java applet update apparatus, java applet execution/processing apparatus, java applet update program, and java applet execution/processing program

(75) Inventor: Masatoshi Kouda, Maebashi (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/314,070

(22) Filed: Dec. 22, 2005

Related U.S. Application Data
(63) Continuation of application No. PCT/JP03/08195, filed on Jun. 27, 2003.

(51) Int. Cl. G06F 15/177

(52) U.S. Cl. 709/220

(57) ABSTRACT

A Java applet execution/processing apparatus is provided in a client that can be connected to a server having Java applet and an execution module. At the time when performing predetermined processing using the Java applet and execution module, the Java applet execution/processing apparatus performs the predetermined processing using Java applet stored in the client in the case where it is determined that the Java applet on the server side has not been updated relative to the Java applet that has already been downloaded and stored in the client. The Java applet execution/processing apparatus comprises: a time zone setting section that sets a time zone during which the predetermined processing is not performed; and a Java applet update section that downloads and stores updated Java applet in the case where there exists, on the server side, Java applet that has been updated relative to the Java applet on the client during the set time zone.

This is a continuing application, filed under 35 U.S.C. §111(a), of International Application PCT/JP03/08195, filed Jun. 27, 2003.

### TECHNICAL FIELD

The present invention relates to a Java applet update apparatus, Java applet execution/processing apparatus, Java applet update program, and Java applet execution/processing program that are applied to a client/server system in which a Web browser operates such that when a client inquires of a server for the date of a file containing Java applet (target file) and determines the target file has been updated based on the result of the inquiry, the client downloads the target file from the server.

### BACKGROUND ART

A prior art that performs predetermined processing using Java applet will be described with reference to FIGS. 4 to 6. FIG. 4 shows a basic system configuration and operation of the prior art. More specifically, FIG. 4 (a) shows a basic system configuration, FIG. 4 (b) shows a state at the resource (Java applet) distribution time, and FIG. 4 (c) shows a state at the Java applet execution time. FIG. 5 is a view for explaining operation of a resource distribution server and a server that provides the resource to a client at the resource distribution time. FIG. 6 is a view for explaining operation of the server and client.

As shown in FIG. 4, a conventional system is constituted by a resource distribution server 1 that distributes Java applet (execution module) which is a distribution resource, a server 2 that stores the Java applet distributed from the resource distribution server 1 in a storage apparatus 2a, and a client 3 that downloads the Java applet from the server 2 and performs predetermined processing using the obtained Java applet. The client 3 has a cache 3a that stores the downloaded Java applet and an execution section 3b that performs predetermined processing using the Java applet stored in the cache 3a.

Next, the distribution operation of Java applet shown in FIG. 4 (b) will be described with reference to FIG. 5. When Java applet is updated, the resource distribution server 1 stores the updated Java applet in the own storage apparatus 1a and allows the storage apparatus 2a of the server 2 to store the same updated Java applet (step S1). When the distribution processing is completed, the resource distribution server 1 creates a change file list FL of Java applet (execution module) and sends the change file list FL to the server 2 (step S2).

The above operation is generally performed during off-hours of the client side so as not to interrupt office operation or the like.

Next, execution operation using Java applet shown in FIG. 4 (c) will be described with reference to FIG. 6.

In the Java applet environment, when a Web browser functional section of the client 3 starts Java applet (class file) (step S11), a Web browser inquires of the server 2 for the date of Java applet file on the server and acquires the date of Java applet file on the server (step S12) as well as acquires the date of Java applet file stored in the cache 3a of the client 3 (step 13). The Web browser functional section then compares the dates of the Java applet files. When determining that the Java applet on the server has been updated relative to the Java applet on the client (no in step S14), the browser functional section downloads the Java applet on the server 2, updates the Java applet stored in the cache 3a (step S15), and performs processing using the updated Java applet (step S16). On the other hand, when determining that the Java applet on the server has not been updated (yes in step S14), the browser functional section performs processing using the Java applet in the cache 3a. When an execution instruction of another class occurs at a subsequent time (step S17), the same operation as above is performed.

As described above, when the Java applet on the server has been updated, the client side starts to download the latest Java applet from the server. Therefore, when a user starts Java applet on the Web browser on the client side to run business application software so as to start processing, he or she needs to wait until the download of the Java applet has been completed. The length of the waiting time depends on the usage pattern of Java applet. Anyway, the occurrence of the waiting time decreases working efficiency of operation based on Java applet, which may lead to a reduction in availability of Java applet.

Prior arts that allow a server to provide the latest program to a client to automatically update the program to be used on the client side are known (refer to, for example, Patent Documents 1 and 2). However, in the environment of the above prior arts, processing need not be always performed using the latest program and update (reception) timing of the latest program can arbitrarily set irrespective of whether target processing is performed or not. That is, unlike the present invention relating to Java applet environment, the above prior arts are not related to the environment in which update processing of a program with the latest one automatically occurs every time a client is started. An object of the present invention is to increase use efficiency of a program that cooperates with a server to perform processing using the latest program.

(Patent Document 1)

Jpn. Pat. Appln. Laid-Open Publication No. 9-128220 (Pages 1 to 3)

(Patent Document 2)

Jpn. Pat. Appln. Laid-Open Publication No. 7-225724 (Page 1)

As described above, an object of the present invention is to provide a Java applet update apparatus, Java applet execution/processing apparatus, Java applet update program, and Java applet execution/processing program capable of eliminating the need to download the latest Java applet at the time when a user starts running business application software using Java applet on a Web browser by previously updating Java applet stored in a cache of a client even if Java applet to be used in business application software has been updated on a server side and thereby capable of eliminating the need for the user to wait until completion of the download to increase workability and use efficiency of Java applet and thereby capable of reducing the stress on the user utilizing the business application software.

### DISCLOSURE OF INVENTION

The present invention is based on a client/server system in which a Web browser that inquires of a server for the date of Java applet (class file) every time the Java applet is executed on a client and, if the Java applet is updated, downloads the updated Java applet runs. In such a system, according to the present invention, a list of Java applets that have been updated during off-hours of the operation (before the start of the business day, etc.) is sent from the server to the respective clients according to an instruction of each client. When determining that the Java applet on the server side has been updated relative to the Java applet on the client based on the list, the client downloads the updated Java applet and stores the updated Java applet in a cache before the start of the business day. Accordingly, the latest Java applet is always stored in the cache at the time when Java applet is executed on the client side after the start of office operation. This eliminates the download processing of the latest Java applet, thereby eliminating the need for a user to wait until completion of the download to allow the user to start his or her work immediately. The present invention has been made to provide an apparatus and program achieving the above advantage.

According to a first aspect of the present invention, there is provided a Java applet update apparatus provided in a client that performs predetermined processing using Java applet downloaded from a server having Java applet as an execution module and connecting the client to the server to perform update processing of Java applet on the client side, comprising: a time zone setting section that sets a time zone during which the predetermined processing is not performed; and a Java applet update section that downloads and stores updated Java applet in the case where there exists, on the server side, Java applet that has been updated relative to the Java applet on the client during the set time zone.

In the Java applet update apparatus, the Java applet update section comprises an update determination section that determines whether there exists, on the server side, Java applet that has been updated relative to the Java applet on the client. In the case where the update determination section determines that there exists, on the server side, Java applet that has been updated relative to the Java applet on the client, the Java applet update section downloads and stores the updated Java applet.

Further, the Java applet update determination section comprises an update file list acquisition section that acquires an update file list related to Java applet from the server. The Java applet update determination section compares the update file list acquired by the update file list acquisition section and an update file list that the client has already acquired and stored to thereby determine whether there exists, on the server side, Java applet that has been updated relative to the Java applet on the client.

The time zone setting section is realized by a time scheduler or sets the time zone by determining that the predetermined processing using Java applet is not performed.

The server updates Java applet on the server during the time zone within which the predetermined processing is not performed on the client side.

According to a second aspect of the present invention, there is provided a Java applet execution/processing apparatus provided in a client that can be connected to a server having Java applet as an execution module and, at the time when performing predetermined processing using downloaded Java applet, performing the predetermined processing using Java applet stored in the client in the case where it is determined that the Java applet on the server side has not been updated relative to the Java applet that has already been downloaded and stored in the client, comprising: a time zone setting section that sets a time zone during which the predetermined processing is not performed; and a Java applet update section that downloads and stores updated Java applet in the case where there exists, on the server side, Java applet that has been updated relative to the Java applet on the client during the set time zone.

According to a third aspect of the present invention, there is provided a Java applet update program provided in a client that performs predetermined processing using Java applet downloaded from a server having Java applet as an execution module and connecting the client to the server to allow the client to perform update processing of Java applet on the client side, the program allowing a computer to execute: a time zone setting step that sets a time zone during which the predetermined processing is not performed; and a Java applet update step that downloads and stores updated Java applet in the case where there exists, on the server side, Java applet that has been updated relative to the Java applet on the client during the set time zone.

The Java applet update step comprises an update determination step that determines whether there exists, on the server side, Java applet that has been updated relative to the Java applet on the client. The Java applet update step downloads and stores the updated Java applet in the case where the update determination step determines that there exists, on the server side, Java applet that has been updated relative to the Java applet on the client.

According to a fourth aspect of the present invention, there is provided a Java applet execution/processing program provided in a client that can be connected to a server having Java applet as an execution module and, at the time when allowing the client to perform predetermined processing using downloaded Java applet, allowing the client to perform the predetermined processing using Java applet stored in the client in the case where it is determined that the Java applet on the server side has not been updated relative to the Java applet that has already been downloaded and stored in the client, the program allowing a computer to execute: a time zone setting step that sets a time zone during which the predetermined processing is not performed; and a Java applet update step that downloads and stores updated Java applet in the case where there exists, on the server side, Java applet that has been updated relative to the Java applet on the client during the set time zone.

### BRIEF DESCRIPTION OF DRAWINGS

FIG. 1 is a block diagram showing a configuration of the entire system according to an embodiment of the present invention;

FIG. 2 shows a basic configuration and operation of the system, and more specifically, FIG. 2 (a) shows a basic system configuration, FIG. 2 (b) shows a state at the resource (Java applet) distribution time, FIG. 2 (c) shows a state at the Java applet update time, and FIG. 2 (d) shows a state at the Java applet execution time;

FIG. 3 shows resource distribution operation and Java applet update operation;

FIG. 4 shows a basic system configuration and operation of the prior art and more specifically, FIG. 4 (a) shows a basic system configuration, FIG. 4 (b) shows a state at the resource (Java applet) distribution time, and FIG. 4 (c) shows a state at the Java applet execution time;

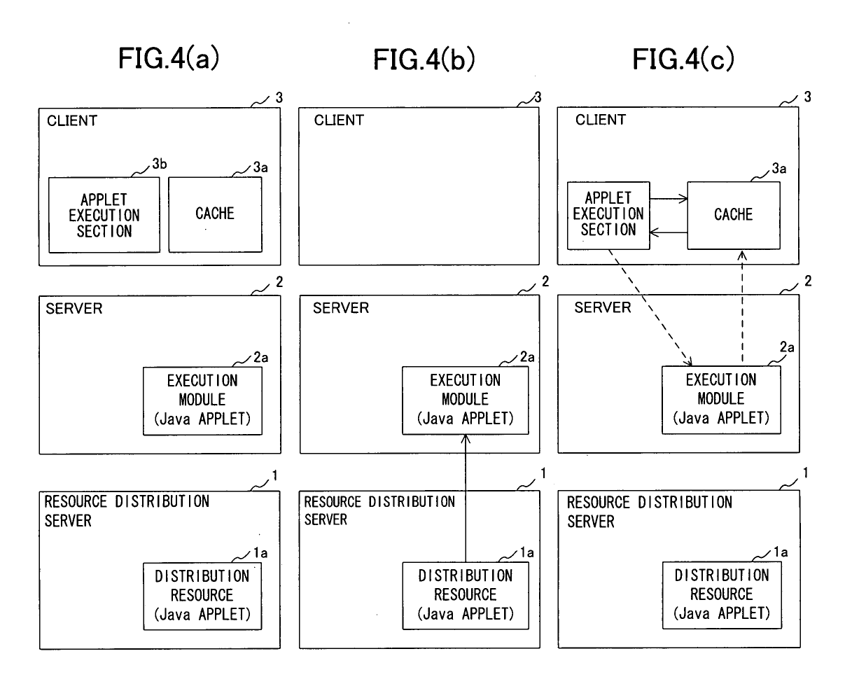

FIG. 5 is a view for explaining operation of a resource distribution server and a server that provides the resource to a client at the resource distribution time; and

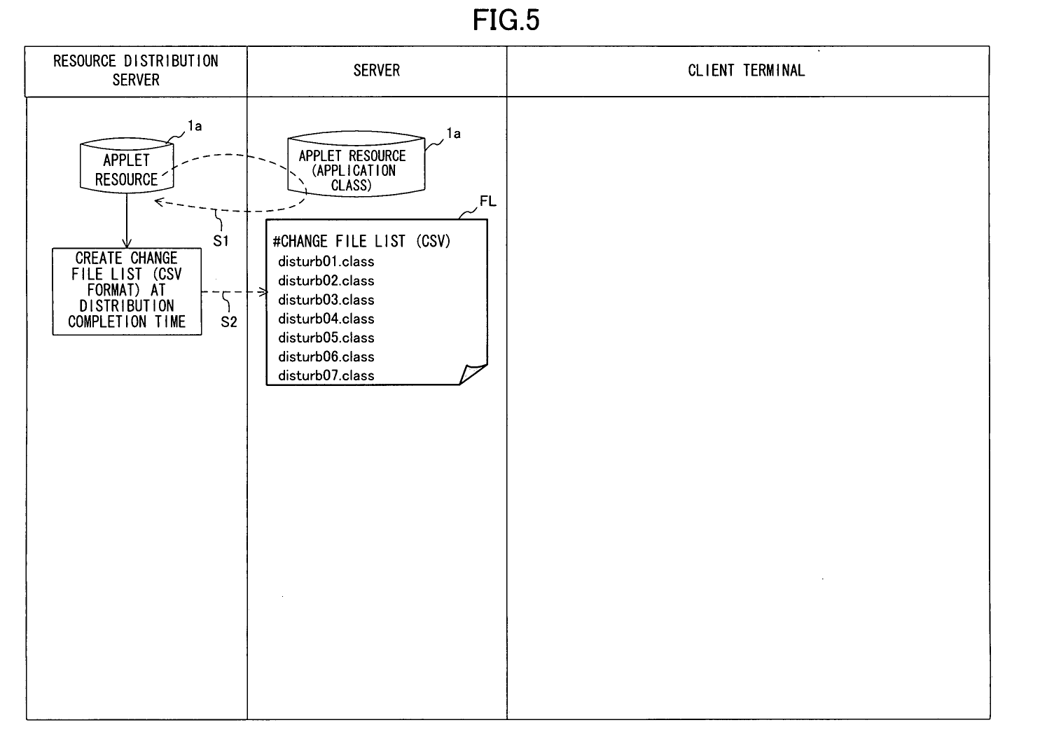

FIG. 6 is a view for explaining conventional operation of the server and client.

### BEST MODE FOR CARRYING OUT THE INVENTION

An embodiment of the present invention will be described with reference to the accompanying drawings.

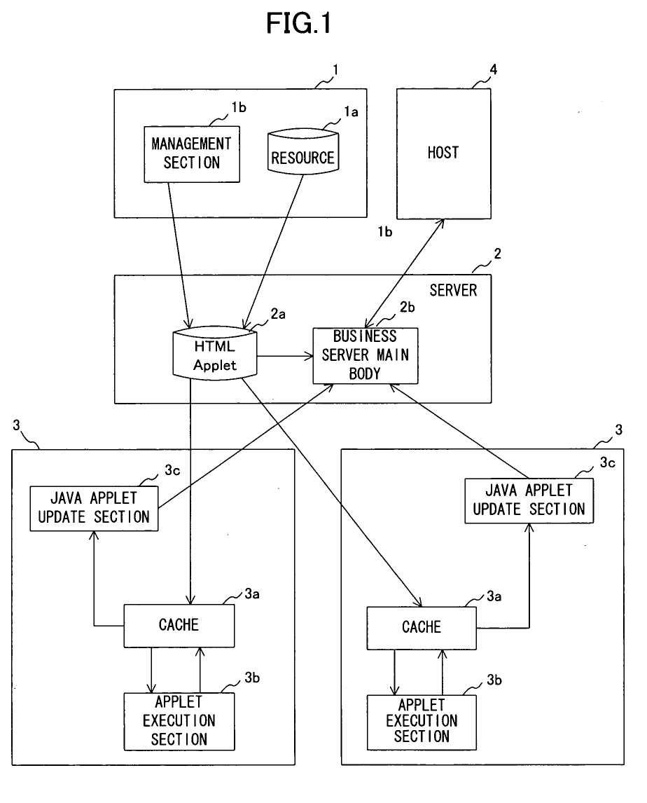

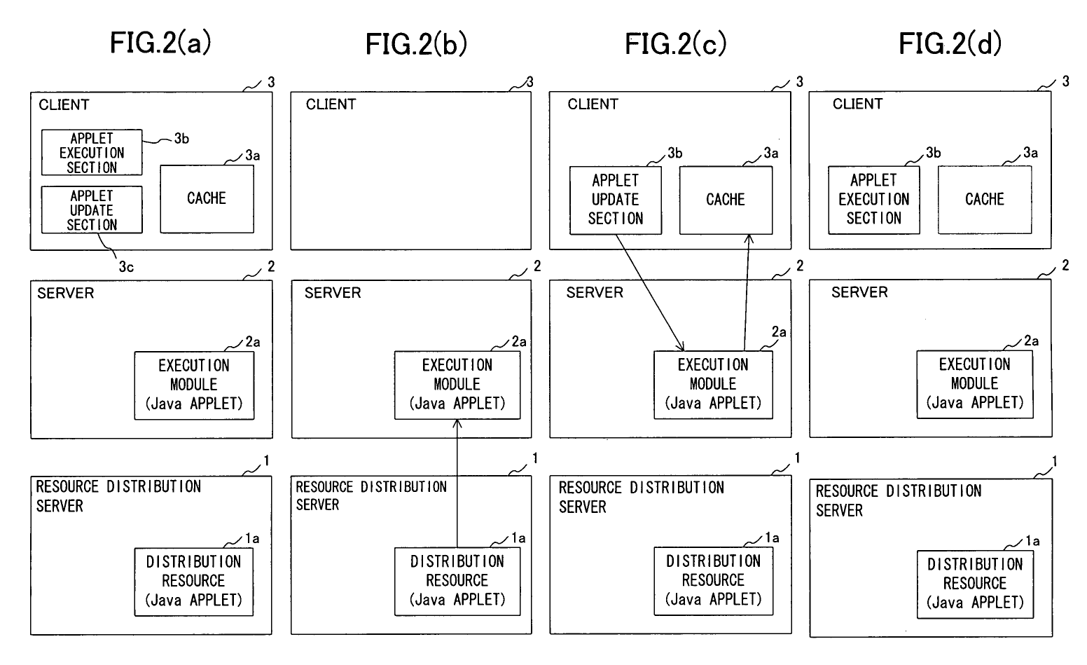

FIG. 1 is a block diagram showing a configuration of the entire system according to the embodiment, and FIG. 2 is a view showing a basic configuration and operation of the system.

The entire system in the embodiment is constituted by a resource distribution server 1 that distributes Java applet (execution module) which is a distribution resource, a server 2 that stores the Java applet distributed from the resource distribution server 1, and a client 3 that downloads the Java applet from the server 2 and performs predetermined processing using the obtained Java applet.

The resource distribution server 1 has a storage apparatus 1a that stores a distribution resource and a management section 1b that manages the distribution of the distribution resource.

The server 2 has a storage apparatus 2a that stores Java applet which is a resource distributed from the resource distribution server 1 and a business server main body 2b that supports the operation of the client 3.

The client 3 has a cache 3a that stores the downloaded Java applet, an applet execution section 3b that performs predetermined processing using the Java applet stored in the cache 3a, and an applet update section (Java applet update apparatus) 3c for updating the Java applet stored in the cache 3a. The cache 3a, the applet execution section 3b and the applet update section 3c constitute a Java applet execution/processing apparatus of the present invention. The applet update section 3c constitutes a Java applet update apparatus of the present invention. A host 4 can be connected to the server 2.

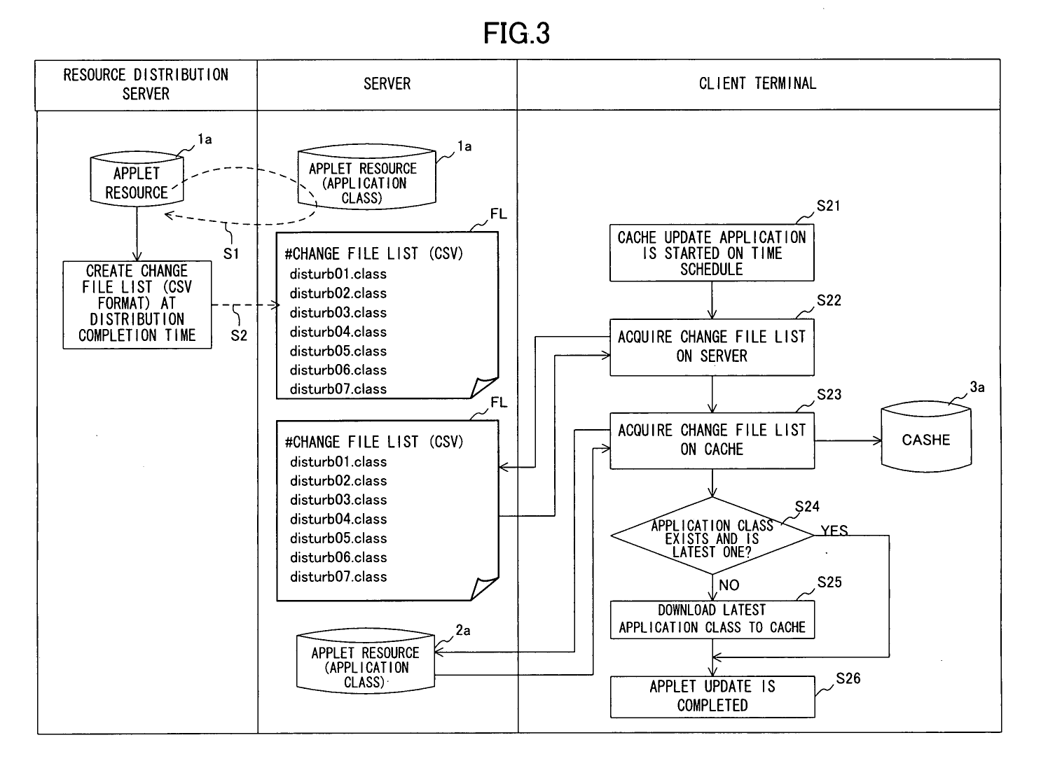

Operation of the embodiment will be described below with reference to FIGS. 2 and 3. In FIG. 2, FIG. 2 (a) shows a basic system configuration, FIG. 2 (b) shows a state at the resource (Java applet) distribution time, FIG. 2 (c) shows a state at the Java applet update time, and FIG. 2 (d) shows a state at the Java applet execution time. FIG. 3 shows resource distribution operation and Java applet update operation.

The Java applet distribution operation shown in FIG. 2 (b) will be described with reference to FIG. 3. When Java applet is updated, the resource distribution server 1 stores the updated Java applet in the own storage apparatus 1a and allows the storage apparatus 2a of the server 2 to store the same updated Java applet (step S1). When the distribution processing is completed, the resource distribution server 1 creates a change file list FL of Java applet (execution module) and sends the change file list FL to the server 2 (step S2). The above operation is generally performed during off-hours of the client side so as not to interrupt office operation.

Next, the Java applet update processing shown in FIG. 2 (c) will be described with reference to FIG. 3.

Firstly, at a certain time after completion of the Java applet distribution operation, the applet update section 3c is started on a time schedule (step S21), and acquires the change file list (date of application class file) on the server (step S22) as well as the change file list stored in the cache (step S23). The applet update section 3c then determines whether the application class (Java applet) stored in the cache is the latest one (step S24). When determining that the application class in the cache is not the latest one (no in step S24), the applet update section 3c downloads the latest application class to the cache 3a (step S25) and ends the processing (step S26). On the other hand, when determining that the application class stored in the cache 3a is the latest one (yes in step S24), the applet update section 3c ends the processing (step S26).

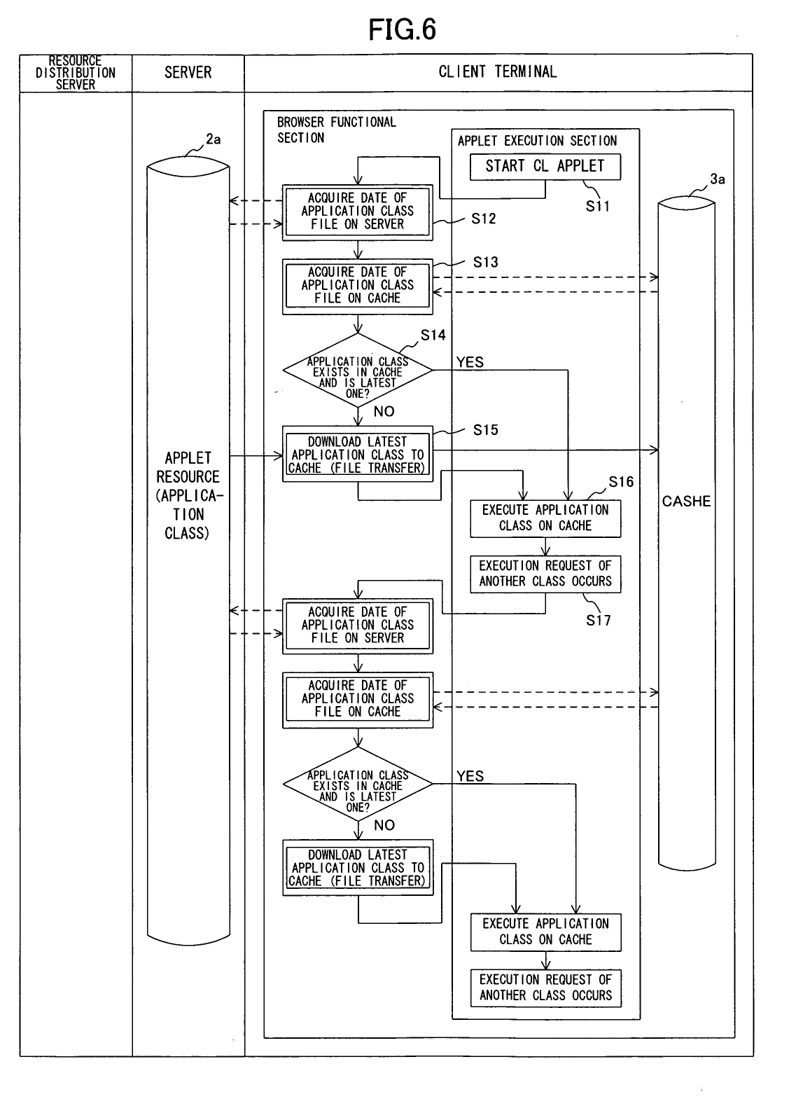

Next, Java applet execution processing shown in FIG. 2 (d) will be described. In this case, the same processing as that shown in FIG. 6, which is the operation of the prior art, is started along with the start of Java applet. However, the updated Java applet has already been stored in the cache 3a at the time point of the determination step (step S14) shown in FIG. 6, so that the download step (step S15) is not generated. Therefore, it is possible to start the processing using Java applet immediately after the start of Java applet.

In the above embodiment, the applet update section 3c is started on a time schedule in step S21. Alternatively, however, a determination section that determines whether processing using Java applet is being performed or not at a given time point may be provided in the Java applet update section 3c. In this case, when the determination section determines that the processing using Java applet is not being performed at a given time point, the Java applet update time zone is set (update processing is performed) immediately at the time point. A time zone setting section of the present invention may include a time scheduler. In the case where the Java applet update apparatus does not include a time scheduler, an activation section provided in the Java applet update apparatus may realize the time zone setting section. In this case, the activation section activates the Java applet update apparatus by receiving an activation instruction from an external time scheduler.

### INDUSTRIAL APPLICABILITY

As described above in detail, according to the present invention, it is possible to previously update Java applet stored in a cache of a client before a user starts running business application software using Java applet on a Web browser even if Java applet to be used in business application software has been updated on a server side. This eliminates the download processing of the latest Java applet to be performed at the start of the work, thereby eliminating the need for a user to wait until completion of the download. As a result, workability and use efficiency of Java applet can be increased. Further, the stress on the user utilizing the business application software can be reduced.

1. A Java applet update apparatus provided in a client that performs predetermined processing using Java applet downloaded from a server having Java applet as an execution module and connecting the client to the server to perform update processing of Java applet on the client side, comprising:
a time zone setting section that sets a time zone during which the predetermined processing is not performed; and
a Java applet update section that downloads and stores updated Java applet in the case where there exists, on the server side, Java applet that has been updated relative to the Java applet on the client during the set time zone.

2. The Java applet update apparatus according to claim 1, wherein
the Java applet update section comprises an update determination section that determines whether there exists, on the server side, Java applet that has been updated relative to the Java applet on the client, the Java applet update section downloads and stores the updated Java applet in the case where the update determination section determines that there exists, on the server side, Java applet that has been updated relative to the Java applet on the client.

3. The Java applet update apparatus according to claim 2, wherein
the Java applet update determination section comprises an update file list acquisition section that acquires an update file list related to Java applet from the server, and the Java applet update determination section compares the update file list acquired by the update file list acquisition section and an update file list that the client has already acquired and stored to thereby determine whether there exists, on the server side, Java applet that has been updated relative to the Java applet on the client.

4. The Java applet update apparatus according to claim 1, wherein
the time zone setting section is realized by a time scheduler.

5. The Java applet update apparatus according to claim 1, wherein
the time zone setting section sets the time zone by determining that the predetermined processing using Java applet is not performed.

6. The Java applet update apparatus according to claim 1, wherein
the server updates Java applet on the server during the time zone within which the predetermined processing is not performed on the client side.

7. A Java applet execution/processing apparatus provided in a client that can be connected to a server having Java applet as an execution module and, at the time when performing predetermined processing using downloaded Java applet, performing the predetermined processing using Java applet stored in the client in the case where it is determined that the Java applet on the server side has not been updated relative to the Java applet that has already been downloaded and stored in the client, comprising:
a time zone setting section that sets a time zone during which the predetermined processing is not performed; and
a Java applet update section that downloads and stores updated Java applet in the case where there exists, on the server side, Java applet that has been updated relative to the Java applet on the client during the set time zone.

8. A Java applet update program provided in a client that performs predetermined processing using Java applet downloaded from a server having Java applet as an execution module and connecting the client to the server to allow the client to perform update processing of Java applet on the client side, the program allowing a computer to execute:
a time zone setting step that sets a time zone during which the predetermined processing is not performed; and
a Java applet update step that downloads and stores updated Java applet in the case where there exists, on the server side, Java applet that has been updated relative to the Java applet on the client during the set time zone.

9. The Java applet update program according to claim 8, wherein
the Java applet update step comprises an update determination step that determines whether there exists, on the server side, Java applet that has been updated relative to the Java applet on the client, and the Java applet update step downloads and stores the updated Java applet in the case where the update determination step determines that there exists, on the server side, Java applet that has been updated relative to the Java applet on the client.

10. A Java applet execution/processing program provided in a client that can be connected to a server having Java applet as an execution module and, at the time when allowing the client to perform predetermined processing using downloaded Java applet, allowing the client to perform the predetermined processing using Java applet stored in the client in the case where it is determined that the Java applet on the server side has not been updated relative to the Java applet that has already been downloaded and stored in the client, the program allowing a computer to execute:
a time zone setting step that sets a time zone during which the predetermined processing is not performed; and
a Java applet update step that downloads and stores updated Java applet in the case where there exists, on the server side, Java applet that has been updated relative to the Java applet on the client during the set time zone.
